(19) United States
(12) Patent Application Publication
(10) Pub. No.: US 2019/0114646 A1
(43) Pub. Date: Apr. 18, 2019

(54) SYSTEM AND METHOD FOR MANAGEMENT OF GAINED AMELIORATING BENEFITS

(71) Applicant: TUN TUN WIN, Yangon (MM)

(72) Inventor: TUN TUN WIN, Yangon (MM)

(21) Appl. No.: 15/785,449

(22) Filed: Oct. 17, 2017

(51) Int. Cl. G06Q 30/00

(52) U.S. Cl. CPC G06Q 30/012; G06Q 20/363

(57) ABSTRACT

Exemplary embodiments of the present disclosure are directed towards a system and method for management of gained ameliorating benefits. The system comprising an ameliorating benefits managing platform configured to manage a gained plurality of ameliorating benefits, the gained plurality of ameliorating benefits provided by a provider's computing device for performing a plurality of activities. The system further comprising a customer's computing device configured to allow a customer to monitor the plurality of gained ameliorating benefits by the ameliorating benefits managing platform. The ameliorating benefits managing platform is configured to allow the provider to register a plurality of details.

### TECHNICAL FIELD

The present disclosure generally relates to the field of systems and methods for management of ameliorating benefits. More particularly, the present disclosure relates to system and method for organizing management of ameliorating benefits for performed activities on a networked platform.

### BACKGROUND

In today's competitive business world every product or service based entity is providing warranties, guarantees and lot of schemes or promotional offers for their products/services. A warranty is an obligation that a service or product sold is as factually stated or legally implied by the company, and that often provides for a specific remedy such as repair or replacement in the event the product or service fails to meet the warranty.

Carrying the warranty cards by the customer is difficult However, it is very difficult to find the warranties or any other information related to the warranties when the product actually fails due to the fact that such papers are easily lost or misplaced by the customer. As a result, many customers cannot take the advantage of warranties that may still be in effect when a failure of a product occurs. Moreover, some customers capture the warranty information and store onto a computing device. However, these computer files may be accidentally deleted or forgotten.

In the light of aforementioned discussion there exists need for a system and method that would overcome or ameliorate the above mentioned disadvantages.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards monitoring ameliorating benefits by the customer from anywhere without carrying hard copies of warrantee cards or guaranty cards.

Another objective of the present disclosure is directed towards winning ameliorating benefits by the customer after performing activities.

According to an exemplary aspect of the present disclosure, the system includes an ameliorating benefits managing platform configured to manage a plurality of gained ameliorating benefits, the plurality of gained ameliorating benefits are provided by a provider for performing a plurality of activities.

According to an exemplary aspect of the present disclosure, the system further includes a customer's computing device configured to allow a customer to monitor the plurality of gained ameliorating benefits by the ameliorating benefits managing platform, the ameliorating benefits managing platform is configured to allow accessing a provider with the provider's computing device to register a plurality of things.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1A is a diagram depicting a system for management of ameliorating benefits, according to exemplary embodiments of the present disclosure.

FIG. 1B is a diagram depicting the ameliorating benefits managing platform 102, according to exemplary embodiments of the present disclosure.

FIG. 2A-FIG. 2B are diagrams depicting example screens A-G for process for availing promotional benefits, in accordance with one or more embodiments.

FIG. 2C is a diagram depicting an example screen A, screen H, and screen I for viewing current promotion, in accordance with one or more embodiments.

FIG. 3 is a flow diagram depicting method for management of ameliorating benefits, in one or more exemplary embodiments.

FIG. 4 is a flow diagram depicting method for performing actions to view current ameliorating benefits, in one or more exemplary embodiments.

FIG. 5 is a block diagram illustrating the details of a digital processing system in which various aspects of the present disclosure are operative by execution of appropriate software instructions.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

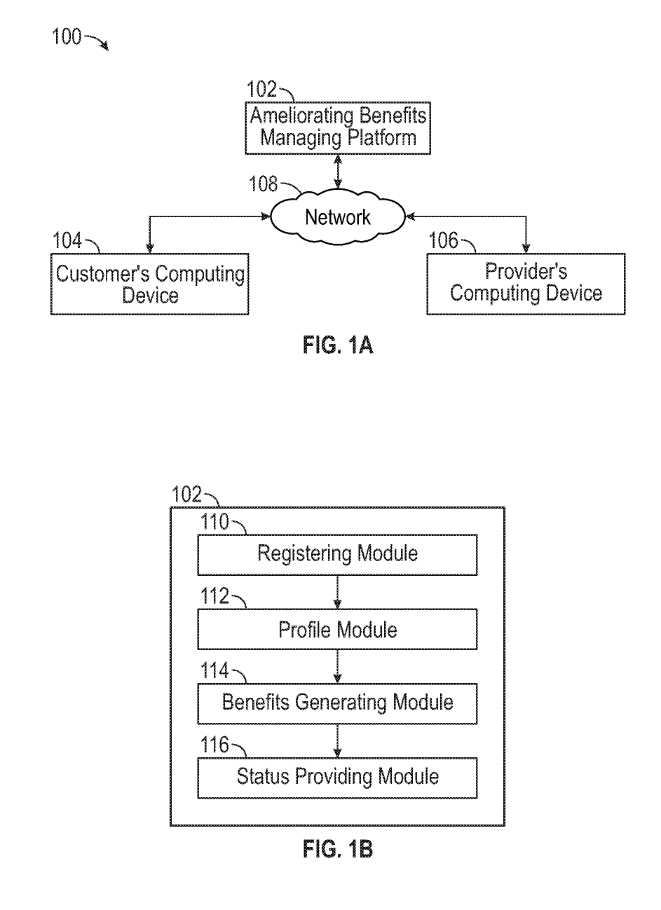

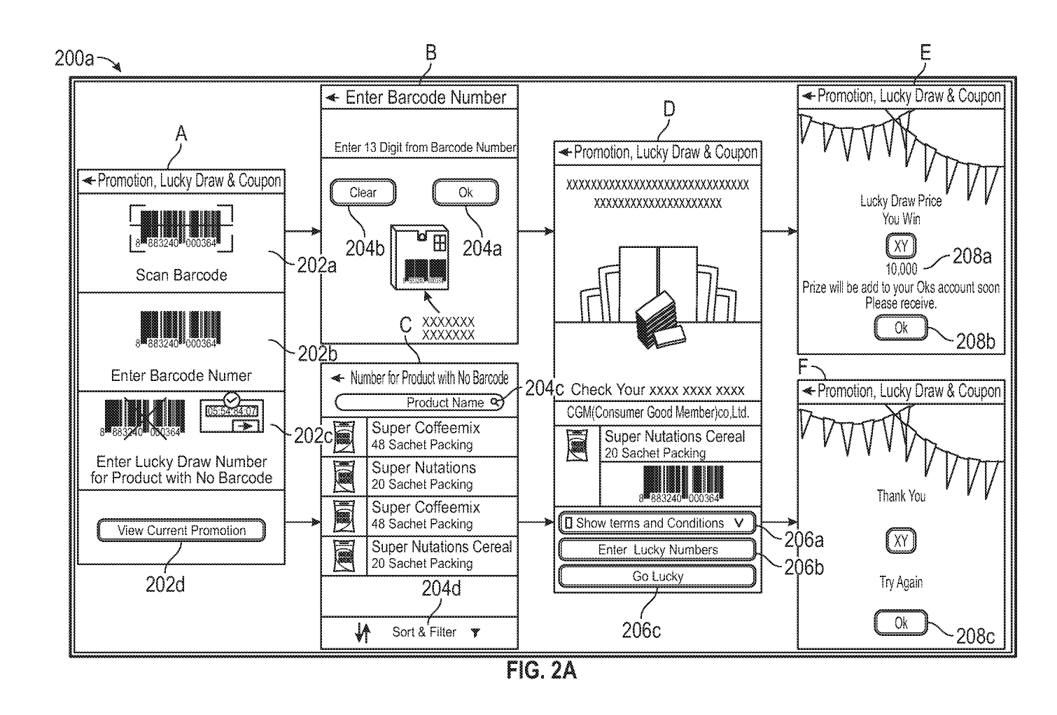

Referring to FIG. 1A is a diagram 100 depicting a system for management of ameliorating benefits, according to exemplary embodiments of the present disclosure. The system 100 includes an ameliorating benefits managing platform 102, a customer's computing device 104, a provider's computing device 106 and a network 108. The network 108 may include, but not limited to, an Ethernet, a wireless local area network (WLAN), or a wide area network (WAN), a WIFI communication network e.g., the wireless high speed internet, or a combination of networks. The network 108 may provide a web interface employing transmission control protocol, hypertext transfer protocol, simple object access protocol or any other internet communication protocol. The customer's computing device 104 and the provider's computing device 106 may include, but not limited to, a computer workstation, an interactive kiosk, and a personal mobile computing device such as a digital assistant, a mobile phone, a laptop, and storage devices, backend servers hosting database and other software or the like.

According to non-limiting exemplary embodiments of the present disclosure, the ameliorating benefits managing platform 102 may be configured to manage ameliorating benefits provided by the provider for the activities performed. The ameliorating benefits may include, but not limited to, warranties, guarantees, lot of schemes or promotional offers, a small amount of penny, discounts for performing activities, gift cards, cash back to digital wallet, digital wallet money, status and warranty expiration dates, warranty claim management, warranty certification storage, warranty repair providers, offer of extended warranties, guaranties, schemes, promotional offers for products and services, and the like. The performed activities may include, but not limited to, purchasing products, using services, making transactions, and the like. The customer's computing device 104 may be configured to allow a customer to monitor the gained ameliorating benefits by the ameliorating benefits managing platform 102. The ameliorating benefits managing platform 102 may be configured to allow the provider using the provider's computing device 106 to register details after providing credentials. The details may include, but not limited to, products, services, promotion products offer and the like. The ameliorating benefits managing platform 102 may be configured to provide a products feature. The products feature may be configured to provide the ameliorating benefits to the customers after purchasing the multiple products. The ameliorating benefits managing platform 102 may further include a prize setting feature. The prize setting feature may be configured to set the prize in terms of an amount, product (for e.g., a designer water, a super coffee), and services (for e.g., one night stay in the vintage hotel). For example, the user can set the prize using the prize setting feature for a spin wheel section in terms of the amount, product (for e.g., a designer water, a super coffee), and services (for e.g., one night stay in the vintage hotel).

According to non-limiting exemplary embodiments of the present disclosure, the customer's computing device 106 may be configured to register with the ameliorating benefits managing platform 102 by providing credentials. The credentials may include, but not limited to, mail id, phone number, name, address, password and the like. The ameliorating benefits managing platform 102 may be configured to be utilized by the customer and the provider which includes offline physical retail outlets, online shopping stores, service providers, business organizations, merchants, dealers, brokers, users and the like. In an example, if the customer purchases a plasma television from the provider by making the payment, the customer gets the ameliorating benefits for making the purchase. The customer may directly check his/her gained ameliorating benefits on the customer's computing device 104 through the ameliorating benefits managing platform 102.

Referring to FIG. 1B is a diagram 100 depicting the ameliorating benefits managing platform 102, according to exemplary embodiments of the present disclosure. The ameliorating benefits managing platform 102 may include a registering module 110, a profile module 112, a benefits generating module 114, a status providing module 116. The registering module 110 may be configured to allow the registration of customer and provider after providing the credentials. The registering module 110 may also be configured to allow the provider to register the details. The profile module 112 may be configured to provide the gained ameliorating benefits based on profiles of the details.

The profile module 112 may also be configured to provide daily ameliorating benefit settings for each profile type according to promotion start and end date. The profile module 112 may include a profile type and a traditional type to provide the gained ameliorating benefits. In profile type, the provider may give ameliorating benefits on the basis of selected state or township, a particular age group of people and the like. In traditional type, direct mapping may happen between the ameliorating benefits and lucky draw numbers. The benefits generating module 114 may be configured to generate benefits to the customer based on lucky draw numbers entered, barcodes, product names or promotion names and the like. The lucky draw numbers, barcodes, product names or promotion names may be printed on the products and coupons. The benefits generating module 114 may also be configured to add the gained ameliorating benefits to a customer digital wallet. If the customer does not win any ameliorating benefit, then the customer may try again to get the ameliorating benefit. The status providing module 116 may be configured to provide current status of the gained ameliorating benefits to the customer.

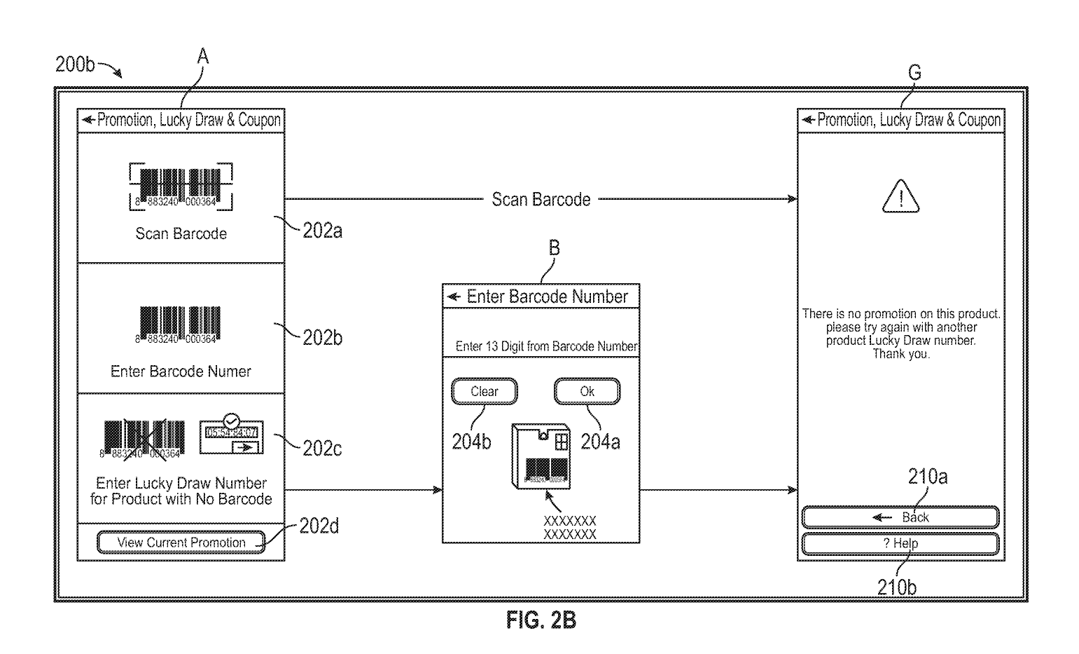

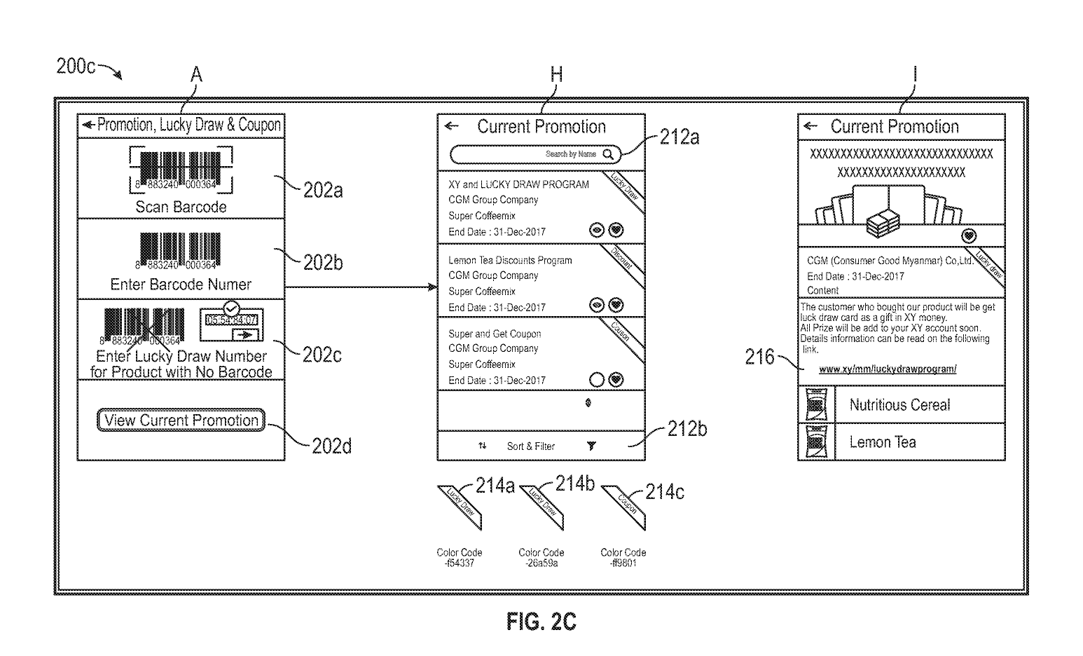

Referring to FIG. 2A-FIG. 2B are diagrams 200a-200b depicting screens A-G for availing promotional benefits, in accordance with one or more embodiments. The FIG. 2A depicts a screen A, which includes scan barcode option 202a, enter barcode option 202b, enter lucky draw number option 202c and view current promotion icon 202d. The scan barcode option 202a may allow the customer to scan the barcode. The enter barcode option 202b may take the barcode number provided by the customer. For e.g., if the customer has 13 digits barcode number and then the customer provides the barcode number on the enter barcode option 202b to get current promotions. Enter lucky draw number option 202c may accept the lucky draw number provided by the customer. For e.g., if the customer hasn't had the barcode number and then the available lucky draw number is helpful to know the current promotions. The screen B depicts an ok icon 204a and a clear icon 204b. The customer may click OK icon 204a to continue the barcode reading process. For any wrong entry of barcode by the customer, the customer needs to click on the clear icon 204b. The customer may enter the product name or lucky draw number on the search bar 204c on the screen C, if the barcode number is not available. The customer may view sort and filter option 204d on the screen C. The sort and filter option 204d may be configured to sort and filter the list of products on the screen C. The screen D may depicts terms and conditions icon 206a, lucky numbers option 206b, and go lucky icon 206c. The terms and conditions icon 206a may be configured to provide terms and conditions for the selected product. The customer may click on the lucky number option 206b and then provide the lucky number for the selected product on the lucky number option 206c. Once the lucky number is provided, the customer may select go lucky icon 206c on the screen D to know the promotions for the selected product. The customer may click on the go lucky icon 206c after entering the lucky number on the lucky number option 206b. The screen E or screen F may appear after clicking the go lucky icon 206c. The screen E depict prize amount won 208a, OK icon 208b. The customer may click on the OK icon 208b after viewing the “prize will be add to your account soon, please receive”. The screen F may depict “thank you” and “try again”. The customer may click on the OK icon 208c after viewing the try again on the screen F.

If the customer enters or scans the barcode on the screen B, then the screen G may appear. The screen G may include back icon 210a, and help icon 210b. The screen G may depict “there is no promotion on this product. Please try again with another product lucky draw number, thank you”. The back icon 210a on the screen G may be configured to bring the initial screens. The help icon 210b may be configured to provide quick guidelines to the customer.

Referring to FIG. 2C is a diagram 200c depicting screen A, screen H, and screen I for viewing current promotion, in accordance with one or more embodiments. The screen A includes scan barcode option 202a, enter barcode option 202b, enter lucky draw number option 202c and view current promotion icon 202d. The scan barcode option 202a may allow the customer to scan the barcode. The enter barcode option 202b may take the barcode number provided by the customer. For e.g., if the customer has 13 digits barcode number and then the customer provides the barcode number on the enter barcode option 202b to get current promotions. Enter lucky draw number option 202c may accept the lucky draw number provided by the customer. For e.g., if the customer hasn't had the barcode number and then the available lucky draw number is helpful to know the current promotions. If the customer clicks on the view current promotion icon 202d, then the screen H may be appear. The screen H may depict a list of current promotions after searching by name on the search bar 212a. The screen H may also depict sort and filter 212b. The sort and filter 212b may be configured to sort and filter the list of current promotions on the screen H. The diagram 200c may further depict color codes 214a-214c for lucky draw, discount, coupon and the like. The color codes 214a-214c may depict in various colors for identifying promotional offers. The customer may select one of promotion from the depicted list of current promotions on the screen H, then the screen I may appear. The screen I may depict the selected promotion details which includes promotion provided company, end date, content and the like. The screen I may further depict a hyperlink 216 to go for home screen.

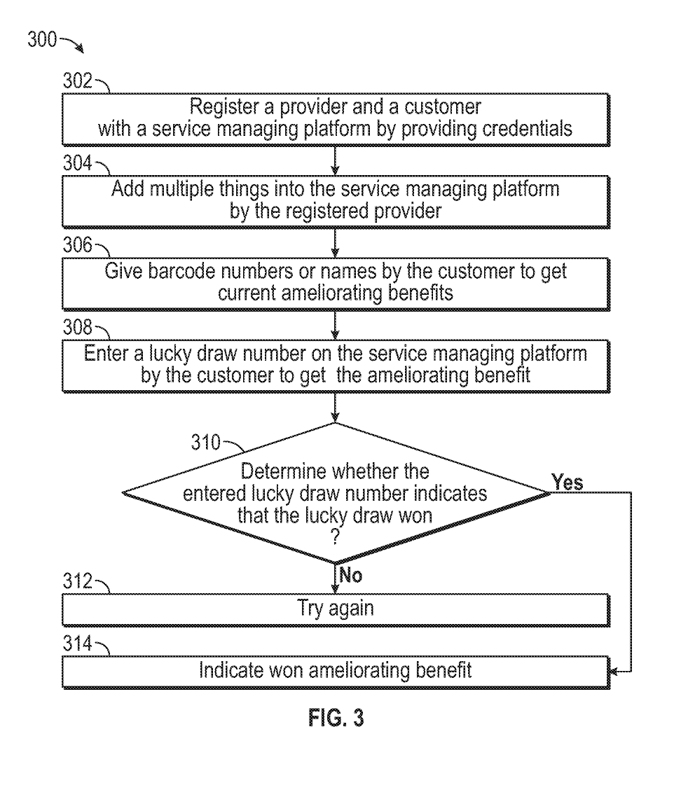

Referring to FIG. 3 is a flow diagram 300 depicting method for management of ameliorating benefits, in one or more exemplary embodiments. Method 300 may be carried out in the context of the details of FIG. 1A-FIG. 1B and FIG. 2A-FIG. 2C. However, method 300 may also be carried out in any desired environment. Further, the aforementioned definitions may equally apply to the description below.

The method commences at step 302, a provider and a customer may register with the ameliorating benefits managing platform. According to the preferred embodiment, the provider may add multiple details to the ameliorating benefits managing platform, at step 304. The provider may give ameliorating benefits on the basis of selected state or township, particular age group of the customers and the like. According to another embodiment, the customer may give the barcode numbers or names to get the current ameliorating benefits on the ameliorating benefits managing platform, at step 306. The barcodes may be scanned or entered manually. According another embodiment, the customer may enter the lucky draw number on the ameliorating benefits managing platform to get the ameliorating benefit, at step 308. The customer may determine whether the entered lucky draw number indicates that the lucky draw won, at step 310. If it is determined that the entered lucky number indicates that the lucky draw has not won, the ameliorating benefits managing platform may indicate try again, at step 312. If it is determined that the entered lucky number indicates that the lucky draw has won, the ameliorating benefits managing platform may indicate the won ameliorating benefit, at step 314.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

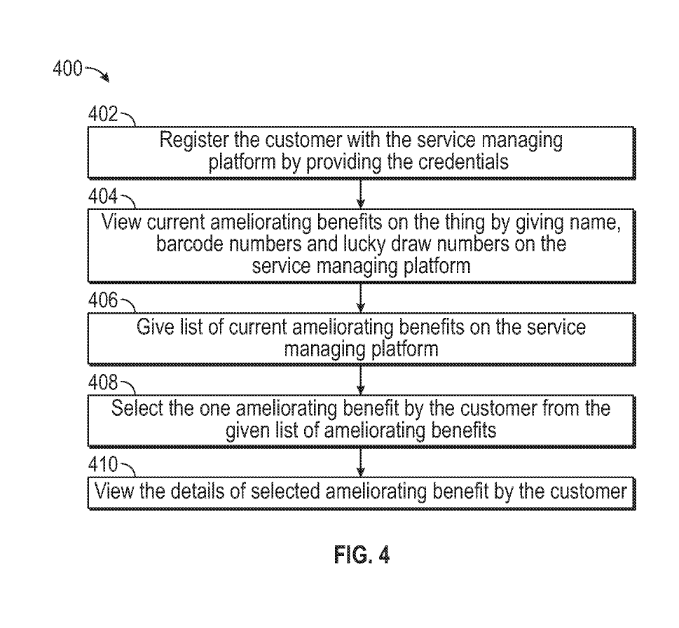

Referring to FIG. 4 is a flow diagram 400 depicting method for performing actions to view current ameliorating benefits, in one or more exemplary embodiments. Method 400 may be carried out in the context of the details of FIG. 1A-FIG. 1B, FIG. 2A-FIG. 2C and FIG. 3. However, method 400 may also be carried out in any desired environment. Further, the aforementioned definitions may equally apply to the description below.

The method commences at step 402, the customer may register with the ameliorating benefits managing platform by providing credentials. The credentials may include, but not limited to, mail id, phone number, name, address, password and the like. According to the preferred embodiment, the customer may view current ameliorating benefits on the details by giving name, barcode numbers and lucky draw numbers on the ameliorating benefits managing platform, at step 404. According to another embodiment, the ameliorating benefits managing platform may give list of current ameliorating benefits, at step 406. The customer may select one ameliorating benefit from the given list, at step 408. According to another embodiment, the customer may view details of the selected ameliorating benefit, at step 410.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

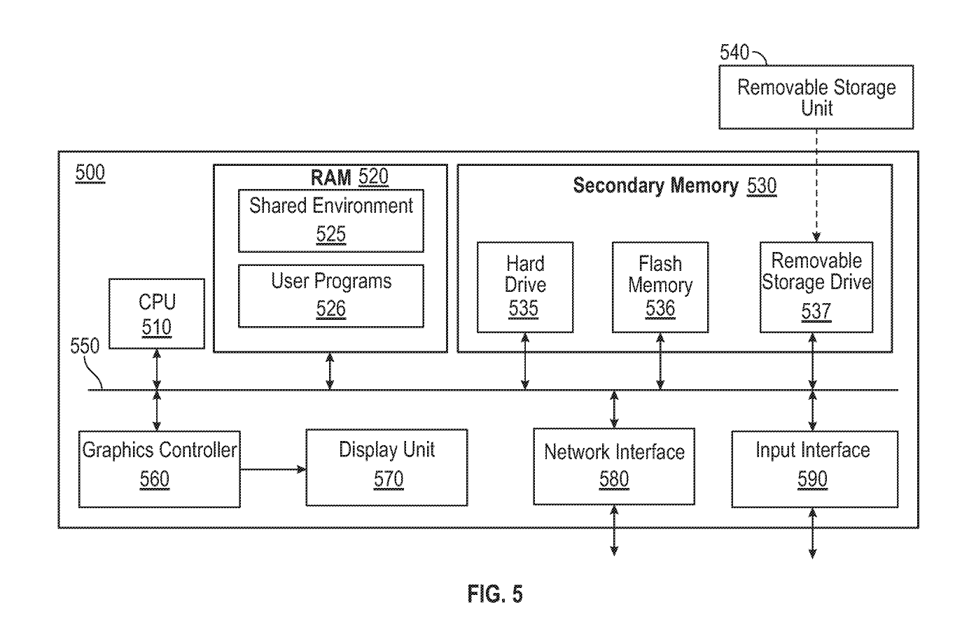

Referring to FIG. 5, FIG. 5 is a block diagram 500 illustrating the details of a digital processing system 500 in which various aspects of the present disclosure are operative by execution of appropriate software instructions. The Digital processing system 500 may correspond to computing devices 106 (or any other system in which the various features disclosed above can be implemented).

Digital processing system 500 may contain one or more processors such as a central processing unit (CPU) 510, random access memory (RAM) 520, secondary memory 527, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present disclosure. CPU 510 may contain multiple processing units, with each processing unit potentially being designed for a specific task. Alternatively, CPU 510 may contain only a single general-purpose processing unit.

RAM 520 may receive instructions from secondary memory 530 using communication path 550. RAM 520 is shown currently containing software instructions, such as those used in threads and stacks, constituting shared environment 525 and/or user programs 526. Shared environment 525 includes operating systems, device drivers, virtual machines, machine language, etc., which provide a (common) run time environment for execution of user programs 526.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse) and may be used to provide inputs. Network interface 580 provides connectivity to a network (e.g., using Internet Protocol), and may be used to communicate with other systems (such as those shown in FIG. 1, network 108) connected to the network.

Secondary memory 530 may contain hard drive 535, flash memory 536, and removable storage drive 537. Secondary memory 530 may store the data software instructions (e.g., for performing the actions noted above with respect to the Figures), which enable digital processing system 500 to provide several features in accordance with the present disclosure.

Some or all of the data and instructions may be provided on removable storage unit 540, and the data and instructions may be read and provided by removable storage drive 537 to CPU 510. Floppy drive, magnetic tape drive, CD-ROM drive, DVD Drive, Flash memory, removable memory chip (PCMCIA Card, EEPROM) are examples of such removable storage drive 537.

Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 may retrieve the software instructions, and execute the instructions to provide various features of the present disclosure described above.

The term “storage media/medium” as used herein refers to any non-transitory media that store data and/or instructions that cause a machine language to operate in a specific fashion. Such storage media may comprise non-volatile media and/or volatile media. Non-volatile media includes, for example, optical disks, magnetic disks, or solid-state drives, such as storage memory 530. Volatile media includes dynamic memory, such as RAM 530. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASHEPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 550. Transmission media can also take the form of acoustic or light waves, such as those generated during radio-wave and infra-red data communications.

Reference throughout this specification to “one embodiment”, “an embodiment”, or similar or any Machine language means that a particular feature, structure, or characteristic described in connection with the embodiment is included in at least one embodiment of the present disclosure. Thus, appearances of the phrases “in one embodiment”, “in an embodiment” and similar or any Machine language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

What is claimed is:

1. A system for management of gained ameliorating benefits for activities performed, comprising:
an ameliorating benefits managing platform configured to manage a plurality of gained ameliorating benefits, wherein the gained plurality of ameliorating benefits provided by a provider for performing a plurality of activities; and
a customer's computing device configured to allow a customer to monitor the gained plurality of ameliorating benefits by the ameliorating benefits managing platform, whereby the ameliorating benefits managing platform configured to allow the provider' to register a plurality of details.

2. The system of claim 1, wherein the ameliorating benefits managing platform comprising a registering module configured to allow the provider and the customer to register by providing a plurality of credentials.

3. The system of claim 1, wherein the ameliorating benefits managing platform comprising a profile module configured to provide the gained plurality of ameliorating benefits based on a plurality of profiles of the plurality of details.

4. The system of claim 1, wherein the ameliorating benefits managing platform comprising a benefits generating module configured to add the plurality of gained ameliorating benefits to a customer digital wallet.

5. The system of claim 1, wherein the ameliorating benefits managing platform comprising a status providing module configured to provide the current status for the gained plurality of ameliorating benefits to the customer.

6. A method for management of gained ameliorating benefits for performed activities, comprising:
registering a plurality of details with a ameliorating benefits managing platform by a provider, whereby the provider contributing a plurality of ameliorating benefits to the registered plurality of details; and
providing a plurality of barcodes, a plurality of names and a plurality of lucky draw numbers by a customer to get the plurality of ameliorating benefits, wherein determining the gained plurality of ameliorating benefits by the ameliorating benefits managing platform.

7. The method of claim 6, further comprising viewing the plurality of ameliorating benefits by the customer for the selected plurality of details.

8. The method of claim 6, further comprising selecting the required plurality of ameliorating benefits by the customer.

9. The method of claim 6, further comprising monitoring a current status for the gained plurality of ameliorating benefits by the customer.
